(19) United States
(12) Patent Application Publication
(10) Pub. No.: US 2013/0071669 A1
(43) Pub. Date: Mar. 21, 2013

(54) COATING SOLUTION FOR FORMING ULTRAVIOLET-ABSORBING FILM AND ULTRAVIOLET-ABSORBING GLASS ARTICLE

(71) Applicant: ASAHI GLASS COMPANY, LIMITED, Chiyoda-ku (JP)

(72) Inventors: Hirokazu Kodaira, Chiyoda-ku (JP); Hiroyuki Tomonaga, Chiyoda-ku (JP)

(73) Assignee: ASAHI GLASS COMPANY, LIMITED, Chiyoda-ku (JP)

(21) Appl. No.: 13/676,651

(22) Filed: Nov. 14, 2012

Related U.S. Application Data
(63) Continuation of application No. PCT/JP2011/061073, filed on May 13, 2011.

(30) Foreign Application Priority Data
May 14, 2010 (JP) 2010-111813

(51) Int. Cl. G02B 5/22

(52) U.S. Cl. CPC G02B 5/22; G02B 5/223
USPC 428/429; 252/588; 252/589

(57) ABSTRACT

There are provided a coating solution for forming an ultraviolet-absorbing film that has mechanical durability such as abrasion resistance, sufficiently secures colorlessness and transparency, and has less deterioration of ultraviolet-absorbing ability caused by long-time light exposure, and an ultraviolet-absorbing glass article having an ultraviolet-absorbing film that is formed by using the coating solution, has mechanical durability such as abrasion resistance, sufficiently secures colorlessness and transparency, and has less deterioration of ultraviolet-absorbing ability caused by long-time light exposure. A coating solution for forming an ultraviolet-absorbing film including: a silicon oxide-based matrix material component consisting of at least one selected from hydrolyzable silicon compounds; an ultraviolet absorber; an acid having a primary proton pKa from of 1.0 to 5.0; and a water and an ultraviolet-absorbing glass article obtained by using it.

### CROSS-REFERENCE TO RELATED APPLICATIONS

This application is a continuation of prior International Application No. PCT/JP2011/061073, filed on May 13, 2011 which is based upon and claims the benefit of priority from Japanese Patent Application No. 2010-111813, filed on May 14, 2010; the entire contents of all of which are incorporated herein by reference.

### FIELD

The present invention relates to a coating solution for forming an ultraviolet-absorbing film on the surface of an article such as glass and an ultraviolet-absorbing glass article having an ultraviolet-absorbing film formed by using the coating solution.

### BACKGROUND

In recent years, it has been attempted that on a transparent substrate such as window glass for a vehicle of an automobile or the like or window glass for a building material attached to a structure of a house, a building, or the like, an ultraviolet-absorbing film having a capability to absorb ultraviolet rays entering the inside of the vehicle or building there through and provided with mechanical durability such as abrasion resistance is formed as a coating film.

In order to obtain the above-described ultraviolet-absorbing coating film having the high abrasion resistance and the ultraviolet-absorbing ability, conventionally, it has been attempted to form a silica-type ultraviolet-absorbing film on a substrate by using a coating solution in which an organic ultraviolet-absorber is incorporated into a silane compound. For example, in Patent Reference 1 (WO 2006/137454), it has been disclosed that a coating solution containing silicon alkoxide and a water-soluble organic polymer such as polyethylene glycol and further containing an ultraviolet absorber and an organic dye is applied on a glass plate and is cured to obtain an ultraviolet-absorbing film made of an organic/inorganic composite film. However, although the silica-type ultraviolet-absorbing film disclosed in Patent Reference 1 has mechanical durability such as abrasion resistance, there have been problems that even in the case of colorlessness and transparency being required, the film becomes yellowish and the ultraviolet-absorbing ability is deteriorated by long-time light exposure.

Thus, there has been required an ultraviolet-absorbing film that sufficiently secures the colorlessness and transparency and has less deterioration of the ultraviolet-absorbing ability caused by long-time light exposure while securing the mechanical durability such as abrasion resistance.

### SUMMARY

The present invention has been made in order to solve the above-described problems and has an object to provide a coating solution for forming an ultraviolet-absorbing film that has mechanical durability such as abrasion resistance, sufficiently secures colorlessness and transparency, and has less deterioration of ultraviolet-absorbing ability caused by long-time light exposure, and an ultraviolet-absorbing glass article having an ultraviolet-absorbing film that is formed by using the coating solution, has mechanical durability such as abrasion resistance, sufficiently secures colorlessness and transparency, and has less deterioration of ultraviolet-absorbing ability caused by long-time light exposure.

The present invention provides a coating solution for forming an ultraviolet-absorbing film and an ultraviolet-absorbing glass article that have the following constitutions.

[1] A coating solution for forming an ultraviolet-absorbing film including: a silicon oxide-based matrix material component consisting of at least one selected from hydrolyzable silicon compounds; an ultraviolet absorber; an acid having a primary proton pKa of from 1.0 to 5.0; and a water.
[2] The coating solution for forming an ultraviolet-absorbing film according to [1], in which the acid is contained in a proportion of from 0.005 to 5.0 mol/kg as the molar concentration, based on the total mass of the coating solution, of the proton when the primary proton of the acid is completely dissociated.
[3] The coating solution for forming an ultraviolet-absorbing film according to [1], in which the acid is at least one selected from the group consisting of acetic acid, lactic acid, maleic acid, malonic acid, and oxalic acid.
[4] The coating solution for forming an ultraviolet-absorbing film according to [1], in which the silicon oxide-based matrix material component contains a tetrafunctional hydrolyzable silicon compound which may contain a partially hydrolyzed condensate thereof as the main component and, the coating solution for forming an ultraviolet-absorbing film further includes a flexibility-imparting component.
[5] The coating solution for forming an ultraviolet-absorbing film according to [1], in which the silicon oxide-based matrix material component contains a tetrafunctional hydrolyzable silicon compound and a trifunctional hydrolyzable silicon compound which may contain their respective partially hydrolyzed condensates and/or a partially hydrolyzed co-condensate of both of them as the main component.
[6] The coating solution for forming an ultraviolet-absorbing film according to [1], in which the ultraviolet absorber is a benzophenone-type ultraviolet absorber.
[7] The coating solution for forming an ultraviolet-absorbing film according to [6], in which the benzophenone-type ultraviolet absorber is a hydrolyzable silicon compound obtained by causing a hydroxylated benzophenone-type compound and an epoxidized hydrolyzable silicon compound to react with each other.
[8] The coating solution for forming an ultraviolet-absorbing film according to [1], in which the content of the ultraviolet absorber is from 1 to 50 parts by mass based on 100 parts by mass of the silicon oxide-based matrix material component.
[9] The coating solution for forming an ultraviolet-absorbing film according to [1], in which the content of the water is from 1 to 20 equivalents by a molar ratio to the amount calculated as SiO₂ of the silicon oxide-based matrix material component.
[10] The coating solution for forming an ultraviolet-absorbing film according to [1] further including fine silica particles.
[11] The coating solution for forming an ultraviolet-absorbing film according to [10], in which the content of the fine silica particles is from 0.5 to 50 parts by mass based on 100 parts by mass of the silicon oxide-based matrix material component.
[12] The coating solution for forming an ultraviolet-absorbing film according to [1], in which the content of the silicon oxide-based matrix material component to the total mass of the coating solution is from 1 to 20 mass % as the content of SiO₂ when silicon atoms contained in the component are calculated as SiO₂.
[13] An ultraviolet-absorbing glass article including: a glass substrate; and an ultraviolet-absorbing film formed on at least part of the glass substrate surface by using the coating solution for forming an ultraviolet-absorbing film according to [1].

As long as the coating solution for forming an ultraviolet-absorbing film of the present invention is used, it becomes possible to form an ultraviolet-absorbing film that has mechanical durability such as abrasion resistance, sufficiently secures colorlessness and transparency, and has less deterioration of ultraviolet-absorbing ability caused by long-time light exposure, and the ultraviolet-absorbing glass article of the present invention having such an ultraviolet-absorbing film is colorless and transparent and has the long durability with respect not only to the mechanical durability but also to the ultraviolet-absorbing ability.

### DETAILED DESCRIPTION

Hereinafter, an embodiment of the present invention will be explained.

### [Coating Solution for Forming an Ultraviolet-Absorbing Film of the Present Invention]

A coating solution for forming an ultraviolet-absorbing film includes: a silicon oxide-based matrix material component consisting of at least one selected from hydrolyzable silicon compounds; an ultraviolet absorber; an acid having a primary proton pKa of from 1.0 to 5.0; and a water.

### <Silicon Oxide-Based Matrix Material Component>

The silicon oxide-based matrix material component contained in the coating solution for forming an ultraviolet-absorbing film of the present invention consists of at least one selected from hydrolyzable silicon compounds. In the present specification, the hydrolyzable silicon compounds are used as a generic name for a group of silane compounds in which at least one hydrolyzable group is bonded to a silicon atom and a group of partially hydrolyzed (co-)condensate of one or two of such silane compounds. Further, the number of functionalities of a hydrolyzable silicon compound means the number of hydrolyzable groups bonded to a silicon atom.

In the coating solution for forming an ultraviolet-absorbing film of the present invention, under the existence of the above-described acid as a catalyst and the water, the hydrolyzable silicon compounds are made into high molecular weight in a manner that the hydrolyzable groups are hydrolyzed to form hydroxyl groups bonded to a silicon atom (namely, silanol groups), and then the silanol groups are subjected to dehydration condensation to form a siloxane bond represented by —Si—O—Si—. From only a bifunctional hydrolyzable silicon compound, linear polysiloxane is formed, and from a trifunctional hydrolyzable silicon compound and a tetrafunctional hydrolyzable silicon compound, a three-dimensional network of polysiloxane is formed, and thereby a silicon oxide-based matrix is formed. Further, also from a mixture of the bifunctional hydrolyzable silicon compound with the trifunctional hydrolyzable silicon compound and/or the tetrafunctional hydrolyzable silicon compound, the three-dimensional network of polysiloxane the silicon oxide-based matrix are formed.

In the coating solution for forming an ultraviolet-absorbing film of the present invention, as the main component of the silicon oxide-based matrix material component, a tetrafunctional hydrolyzable silicon compound which may contain a partially hydrolyzed condensate thereof is preferably contained, and in such a case, a later-described flexibility-imparting component is preferably further contained. Further, as the above-described silicon oxide-based matrix material component, as the main component, it is also preferred to contain a tetrafunctional hydrolyzable silicon compound and a trifunctional hydrolyzable silicon compound which may contain their respective partially hydrolyzed condensates of the tetrafunctional hydrolyzable silicon compound and the trifunctional hydrolyzable silicon compound and/or a partially hydrolyzed co-condensate of them.

A particularly preferred aspect according to the silicon oxide-based matrix material component is an aspect in which the silicon oxide-based matrix material component is constituted of only the tetrafunctional hydrolyzable silicon compound which may contain a partially hydrolyzed condensate thereof and is incorporated into the coating solution for forming an ultraviolet-absorbing film, together with the flexibility-imparting component. Alternatively, it is an aspect in which the silicon oxide-based matrix material component is constituted of the tetrafunctional hydrolyzable silicon compound and the trifunctional hydrolyzable silicon compound which may contain the their respective partially hydrolyzed condensates and/or a partially hydrolyzed co-condensate of them and is incorporated into the coating solution for forming an ultraviolet-absorbing film, together with the flexibility-imparting component according to need.

As the hydrolyzable group that the hydrolyzable silicon compound has, concretely, there can be cited an alkoxy group (including a substituted alkoxy group such as an alkoxy-substituted alkoxy group), an alkenyloxy group, an acyl group, an acyloxy group, an oxime group, an amide group, an amino group, an iminoxy group, an aminoxy group, an alkyl-substituted amino group, an isocyanate group, a chlorine atom, and the like. As the hydrolyzable group among them, an organoxy group such as an alkoxy group, an alkenyloxy group, an acyloxy group, an iminoxy group, or an aminoxy group is preferred, and particularly, an alkoxy group is preferred. As the alkoxy group, an alkoxy group having 4 or less carbon atoms and an alkoxy-substituted alkoxy group having 4 or less carbon atoms (2-methoxyethoxy group and the like) are preferred, and particularly, a methoxy group and an ethoxy group are preferred.

The above-described tetrafunctional hydrolyzable silicon compound is a compound in which four hydrolyzable groups are bonded to a silicon atom. The four hydrolyzable groups may be the same with or may also be different from one another. The hydrolyzable groups are preferably alkoxy groups, are more preferably alkoxy groups each having 4 or less carbon atoms, and are still more preferably a methoxy group and an ethoxy group. Concretely, there can be cited tetramethoxysilane, tetraethoxysilane, tetra-n-propoxysilane, tetra-n-butoxysilane, tetra-sec-butoxysilane, tetra-tert-butoxysilane, and the like, and in the present invention, tetraethoxysilane, tetramethoxysilane, or the like is preferably used. One of them may be used alone, or two or more of them may also be used in combination.

The above-described trifunctional hydrolyzable silicon compound is a compound in which three hydrolyzable groups and one non-hydrolyzable group are bonded to a silicon atom. The three hydrolyzable groups may be the same with or may also be different from one another. The hydrolyzable groups are preferably alkoxy groups, are more preferably alkoxy groups each having 4 or less carbon atoms, and are still more preferably a methoxy group and an ethoxy group.

The non-hydrolyzable group is preferably a non-hydrolyzable monovalent organic group having or not having a functional group, and is more preferably a non-hydrolyzable monovalent organic group having a functional group. The non-hydrolyzable monovalent organic group is an organic group in which the organic group and a silicon atom are bonded by a carbon-silicon bond and a bond terminal atom is a carbon atom.

Here, the functional group used in the present specification is a term comprehensively indicating a reactive group separated from a substituent simply, and a non-reactive group such as, for example, a saturated hydrocarbon group is not included as the functional group. Further, an addition-polymerizable unsaturated double bond (ethylene double bond) such a side group of a monomer which is unrelated to main chain formation of a highly polymerized compound is regarded as one of the functional groups. Further, the term of “(meth)acryl . . . ” of a (meth)acrylic ester or the like used in the present specification is a term meaning both “acryl . . . ” and “methacryl . . . ”.

As for the above-described non-hydrolyzable monovalent organic groups, as the non-hydrolyzable monovalent organic group not having a functional group, a hydrocarbon group not having an addition-polymerizable unsaturated double bond such as an alkyl group or an aryl group, and a halogenated hydrocarbon group not having an addition-polymerizable unsaturated double bond such as a halogenated alkyl group are preferred. As the non-hydrolyzable monovalent organic group not having a functional group, particularly, the number of carbon atoms is 20 or less, and is more preferably 10 or less. As the above monovalent organic group, an alkyl group having 4 or less carbon atoms is preferred.

As the trifunctional hydrolyzable silicon compound having the non-hydrolyzable monovalent organic group not having a functional group, concretely, there can be cited methyltrimethoxysilane, methyltriethoxysilane, methyltris(2-methoxyethoxy)silane, methyltriacetoxysilane, methyltripropoxysilane, methyltriisopropenoxysilane, methyltributoxysilane, ethyltrimethoxysilane, ethyltriethoxysilane, phenyltrimethoxysilane, phenyltriethoxysilane, phenyltriacetoxysilane, and the like. One of them may be used alone, or two or more of them may also be used in combination.

As the functional group in the above-described non-hydrolyzable monovalent organic group having a functional group, there can be cited an epoxy group, a (meth)acryloxy group, a primary or secondary amino group, an oxetanyl group, a vinyl group, a styryl group, an ureido group, a mercapto group, an isocyanate group, a cyano group, a halogen atom, and the like, and an epoxy group, a (meth)acryloxy group, a primary or secondary amino group, an oxetanyl group, a vinyl group, an ureido group, a mercapto group, and the like are preferred. Particularly, an epoxy group, a primary or secondary amino group, and a (meth)acryloxy group are preferred. As a monovalent organic group having an epoxy group, a monovalent organic group having a glycidoxy group or a 3,4-epoxycyclohexyl group is preferred, and as an organic group having a primary or secondary amino group, a monovalent organic group having an amino group, a monoalkylamino group, a phenylamino group, an N-(aminoalkyl)amino group, or the like is preferred.

Two functional groups or more may also exist in the monovalent organic group, and the monovalent organic group having a single functional group is preferred except the case of a primary or secondary amino group. In the case of a primary or secondary amino group, the monovalent organic group may also have two or more amino groups, and in the case, a monovalent organic group having a single primary amino group and a single secondary amino group, which is, for example, an N-(2-aminoethyl)-3-aminopropyl group, a 3-ureidopropyl group, or the like, is preferred. The total number of carbon atoms of the monovalent organic group having these functional groups is preferably 20 or less, and is more preferably 10 or less.

As the trifunctional hydrolyzable silicon compound having the non-hydrolyzable monovalent organic group having a functional group, concretely, the following compounds can be cited. There can be cited vinyltrimethoxysilane, vinyltriethoxysilane, vinyltriacetoxysilane, vinyltris(2-methoxyethoxy)silane, vinyltriisopropenoxysilane, p-styryltrimethoxysilane, 3-glycidoxypropyltrimethoxysilane, 3-glycidoxypropyltriethoxysilane, 5,6-epoxyhexyltrimethoxysilane, 9,10-epoxydecyltrimethoxysilane, 2-(3,4-epoxycyclohexyl)ethyltrimethoxysilane, 2-(3,4-epoxycyclohexyl)ethyltriethoxysilane, N-(2-aminoethyl)-3-aminopropyltrimethoxysilane, N-(2-aminoethyl)-3-aminopropyltriethoxysilane, 3-aminopropyltrimethoxysilane, 3-aminopropyltriethoxysilane, 3-ureidopropyltriethoxysilane, 3-methacryloxypropyltrimethoxysilane, 3-methacryloxypropyltriethoxysilane, 3-acryloxypropyltrimethoxysilane, di-(3-methacryloxy)propyltriethoxysilane, 3-isocyanatepropyltriethoxysilane, 3-chloropropyltrimethoxysilane, 3-chloropropyltriethoxysilane, 3-chloropropyltripropoxysilane, 3,3,3-trifluoropropyltrimethoxysilane, 3-mercaptopropyltrimethoxysilane, 3-mercaptopropyltriethoxysilane, 2-cyanoethyltrimethoxysilane, and the like.

The preferable compound among them is the trifunctional hydrolyzable silicon compound in which a single monovalent organic group having a functional group, which is any one of a glycidoxy group, a 2,3-epoxycyclohexyl group, an amino group, an alkylamino group (the number of carbon atoms of the alkyl group is 4 or less), a phenylamino group, an N-(aminoalkyl)amino group (the number of carbon atoms of the alkyl group is 4 or less), and a (meth)acryloxy group, at a terminal of an alkyl group having 2 or 3 carbon atoms and three alkoxy groups each having 4 or less carbon atoms are bonded to a silicon atom.

As such a compound, concretely, there can be cited 3-glycidoxypropyltrimethoxysilane, 3-glycidoxypropyltriethoxysilane, 2-(3,4-epoxycyclohexyl)ethyltrimethoxysilane, 2-(3,4-epoxycyclohexyl)ethyltriethoxysilane, 3-methacryloxypropyltrimethoxysilane, di-(3-methacryloxy)propyltriethoxysilane, and the like. From the point of reactivity with a silane compound, 3-glycidoxypropyltrimethoxysilane, 3-glycidoxypropyltriethoxysilane, 2-(3,4-epoxycyclohexyl)ethyltrimethoxysilane, 2-(3,4-epoxycyclohexyl)ethyltriethoxysilane, and the like are particularly preferred. One of them may be used alone, or two or more of them may also be used in combination.

Further, in the coating solution for forming an ultraviolet-absorbing film of the present invention, as the silicon oxide-based matrix material component, the bifunctional hydrolyzable silicon compound may also be contained according to need. The bifunctional hydrolyzable silicon compound is a compound in which two hydrolyzable groups and two non-hydrolyzable groups are bonded to a silicon atom. The two hydrolyzable groups may be the same with or may also be different from each other. The hydrolyzable groups are preferably alkoxy groups, are more preferably alkoxy groups each having 4 or less carbon atoms, and are still more preferably a methoxy group and an ethoxy group.

As the non-hydrolyzable group, a non-hydrolyzable monovalent organic group is preferred. The non-hydrolyzable monovalent organic group may also have the same functional group as that of the above-described trifunctional hydrolyzable silicon compound, according to need.

As the above-described bifunctional hydrolyzable silicon compound, concretely, there can be cited dimethyldimethoxysilane, dimethyldiethoxysilane, dimethyldi(2-methoxyethoxy)silane, dimethyldiacetoxysilane, dimethyldipropoxysilane, dimethyldiisopropenoxysilane, dimethyldibutoxysilane, vinylmethyldimethoxysilane, vinylmethyldiethoxysilane, vinylmethyldiacetoxysilane, vinylmethyldi(2-methoxyethoxy)silane, vinylmethyldiisopropenoxysilane, phenylmethyldimethoxysilane, phenylmethyldiethoxysilane, phenylmethyldiacetoxysilane, 3-chloropropylmethyldimethoxysilane, 3-chloropropylmethyldiethoxysilane, 3-chloropropylmethyldipropoxysilane, 3,3,3-trifluoropropylmethyldimethoxysilane, 3-methacryloxypropylmethyldimethoxysilane, 3-acryloxypropylmethyldimethoxysilane, 3-aminopropylmethyldimethoxysilane, 3-aminopropylmethyldiethoxysilane, 3-mercaptopropylmethyldimethoxysilane, 3-mercaptopropylmethyldiethoxysilane, N-(2-aminoethyl)-3-aminopropylmethyldimethoxysilane, 2-cyanoethylmethyldimethoxysilane, and the like. One of them may be used alone, or two or more of them may also be used in combination.

In the coating solution for forming an ultraviolet-absorbing film of the present invention, the above-described tetrafunctional hydrolyzable silicon compound, trifunctional hydrolyzable silicon compound, and bifunction hydrolyzable silicon compound themselves may be incorporated, their respective partially hydrolyzed condensates may be incorporated, or a partially hydrolyzed co-condensate of two or more of them may also be incorporated. Hereinafter, the partially hydrolyzed condensate and the partially hydrolyzed co-condensate are also referred to as a partially hydrolyzed (co-)condensate collectively.

The partially hydrolyzed (co-)condensate is an oligomer (multimer) formed in a manner that the hydrolyzable silicon compound is hydrolyzed and then is subjected to dehydration condensation. The partially hydrolyzed (co-)condensate is such a high molecular weight product to be normally dissolved in a solvent. The partially hydrolyzed (co-)condensate has hydrolyzable groups and/or silanol groups, and has a nature to become a final cured product by being further subjected to hydrolytic (co-)condensation. Only from one of the hydrolyzable silicon compounds, a partially hydrolyzed condensate can be obtained, and from two or more of the hydrolyzable silicon compounds, a partially hydrolyzed co-condensate being a co-condensate of them can also be obtained.

The above-described partially hydrolytic (co-)condensation of the hydrolyzable silicon compound can be performed by stirring a reaction solution in which water is added to a lower alcohol solution of the hydrolyzable silicon compound, at from 10 to 40° C. for from 1 to 48 hours under the existence of an acid catalyst, for example. Incidentally, the type and amount of the acid catalyst to be used for the reaction are set to be the same as those of the acid contained in the coating solution for forming an ultraviolet-absorbing film.

Incidentally, in the coating solution for forming an ultraviolet-absorbing film of the present invention, even though being incorporated in any one of the above-described states, the tetrafunctional hydrolyzable silicon compound, the trifunctional hydrolyzable silicon compound, and the bifunctional hydrolyzable silicon compound are each distinguished as a unit constituting the silicon oxide-based matrix finally. Hereinafter, in the coating solution for forming an ultraviolet-absorbing film of the present invention, as for the tetrafunctional hydrolyzable silicon compound, for example, the tetrafunctional hydrolyzable silicon compound itself and the partially hydrolyzed condensate thereof, and a component derived from the hydrolyzable silicon compound in the partially hydrolyzed co-condensate are together referred to as a component derived from the tetrafunctional hydrolyzable silicon compound.

The silicon oxide-based matrix material component contained in the coating solution for forming an ultraviolet-absorbing film of the present invention is preferably constituted of (1) only the component derived from the tetrafunctional hydrolyzable silicon compound or (2) the component derived from the tetrafunctional hydrolyzable silicon compound and the component derived from the trifunctional hydrolyzable silicon compound, as described above. Incidentally, in the case of (1), the coating solution for forming an ultraviolet-absorbing film preferably contains the flexibility-imparting component in order to obtain sufficient crack resistance while securing a certain film thickness of an obtainable ultraviolet-absorbing film, in particular. Further, in the case of (2), the compounding ratio of the component derived from the tetrafunctional hydrolyzable silicon compound and the component derived from the trifunctional hydrolyzable silicon compound is preferably, as the component derived from the tetrafunctional hydrolyzable silicon compound/the component derived from the trifunctional hydrolyzable silicon compound, from 30/70 to 95/5, is more preferably from 40/60 to 90/10, and is still more preferably from 50/50 to 80/20 by mass ratio.

Further, a component derived from the above-described bifunctional hydrolyzable silicon compound is arbitrarily incorporated in (1) and (2) according to need. The incorporation amount is preferably set to, in mass %, the amount of 30 mass % or less to the total amount of the silicon oxide-based matrix material component.

Further, in the coating solution for forming an ultraviolet-absorbing film of the present invention, the content of the above-described silicon oxide-based matrix material component to the total mass of the coating solution is preferably from 1 to 20 mass % and is more preferably from 3 to 15 mass % as the content of SiO₂ when silicon atoms contained in the silicon oxide-based matrix material component are calculated as SiO₂. If the above content of the silicon oxide-based matrix material component to the total mass of the coating solution is less than 1%, the application amount of the coating solution for obtaining an ultraviolet-absorbing film having a desired film thickness is required to be increased, and as a result, the appearance is likely to deteriorate, and if it exceeds 20 mass %, the film thickness in a state where the coating solution is applied becomes thick, and a crack is likely to occur in the obtainable ultraviolet-absorbing film.

### <Ultraviolet Absorber>

The coating solution for forming an ultraviolet-absorbing film of the present invention contains the ultraviolet absorber so that a film to be formed with the coating solution may function as an ultraviolet-absorbing film. In the coating solution for forming an ultraviolet-absorbing film of the present invention, the acid catalyst is specified, and thereby deterioration of the ultraviolet absorber by light is prevented and long-term use of the ultraviolet absorber is made possible.

As the ultraviolet absorber, concretely, there can be cited organic ultraviolet absorbers of benzophenones, triazines, benzotriazoles, cyanoacrylates, azomethines, indoles, salicylates, anthracenes, and the like. These ultraviolet absorbers include a benzotriazole-type ultraviolet absorber, a triazine-type ultraviolet absorber, a benzophenone-type ultraviolet absorber, a cyanoacrylate-type ultraviolet absorber, an azomethine-type ultraviolet absorber, an indole-type ultraviolet absorber, a salicylate-type ultraviolet absorber, an anthracene-type ultraviolet absorber, and the like, and water dispersions or emulsions made with these compounds, and further complexes of these compounds and metals.

As the above-described benzotriazole-type ultraviolet absorber, concretely, there can be cited 2-[5-chloro(2H)-benzotriazole-2-yl]-4-methyl-6-(tert-butyl)-phenol (as an article on the market, TINUVIN 326 (trade name, manufactured by Ciba Japan K.K.) or the like), octyl-3-[3-tert-4-hydroxy-5-[5-chloro-2H-benzotriazole-2-yl]-propionate, 2-(2H-benzotriazole-2-yl)-4,6-di-tert-pentylphenol, 2-(2-hydroxy-5-methylphenyl)benzotriazole, 2-[2-hydroxy-3-(3,4,5,6-tetrahydrophthalimide-methyl)-5-methyl-phenyl]benzotriazole, 2-(2-hydroxy-5-tert-octylphenyl)benzotriazole, 2-(2-hydroxy-5-tert-butylphenyl)-2H-benzotriazole, methyl3-(3-(2H-benzotriazole-2-yl)-5-t-butyl-4-hydroxyphenyl)-propionate, 2-(2H-benzotriazole-2-yl)-4,6-bis(1-methyl-1-phenylethyl)phenol, 2-(2H-benzotriazole-2-yl)-6-(1-methyl-1-phenylethyl)-4-(1,1,3,3-tetramethylbutyl)phenol, and the like.

As the above-described triazine-type ultraviolet absorber, concretely, there can be cited 2-[4-[(2-hydroxy-3-dodecyloxypropyl)oxy]-2-hydroxyphenyl]-4,6-bis(2,4-dimethylphenyl)-1,3,5-triazine, 2-[4-[(2-hydroxy-3-(2′-ethyl)hexyl)oxy]-2-hydroxyphenyl]-4,6-bis(2,4-dimethylphenyl)-1,3,5-triazine, 2,4-bis(2-hydroxy-4-butoxyphenyl)-6-(2,4-bis-butoxyphenyl)-1,3,5-triazine, 2-(2-hydroxy-4-[1-octylcarbonylethoxy]phenyl)-4,6-bis(4-phenyl-phenyl)-1,3,5-triazine, TINUVIN477 (trade name, manufactured by Ciba Japan K.K.)), and the like.

As the above-described cyanoacrylate-type ultraviolet absorber, concretely, UVINUL3008 (trade name, manufactured by BASF Japan Ltd.) and the like can be cited, as the salicylate-type ultraviolet absorber, concretely, p-t-butylphenylsalicylate, p-octylphenylsalicylate, and the like can be cited, as the anthracene-type ultraviolet absorber, concretely, anthracene, an anthracene derivative, and the like can be cited, as the indole-type ultraviolet absorber, BONASORB UA-3911, BONASORB UA-3912 (trade names, both are manufactured by ORIENT CHEMICAL INDUSTRIES CO., LTD.), and the like can be cited, and as the azomethine-type ultraviolet absorber, BONASORB UA-3701 (trade name, manufactured by ORIENT CHEMICAL INDUSTRIES CO., LTD.), and the like ca be cited.

As the above-described benzophenone-type ultraviolet absorber, concretely, there can be cited 2,4-dihydroxybenzophenone, 2,2′,3 (or any one of 4, 5 and 6)-trihydroxybenzophenone, 2,2′,4,4′-tetrahydroxybenzophenone, 2,4-dihydroxy-2′,4′-dimethoxybenzophenone, 2-hydroxy-4-n-octoxybenzophenone, and the like.

Wavelengths of maximum light absorption of these organic ultraviolet absorbers described as examples each fall within a range of from 325 to 425 nm, and in many cases, fall within a range of from 325 to 390 nm, and the organic ultraviolet absorbers each have an absorption capability also for ultraviolet rays with a relatively long wavelength. In the present invention, one of these ultraviolet absorbers can be used alone, or two or more of these ultraviolet absorbers can also be used in combination. Further, in the coating solution for forming an ultraviolet-absorbing film of the present invention, among these ultraviolet absorbers, the benzophenone-type ultraviolet absorber is preferably used in terms of solubility.

The content of the ultraviolet absorber in the coating solution for forming an ultraviolet-absorbing film of the present invention is preferably from 1 to 50 parts by mass, is more preferably from 5 to 40 parts by mass, and is still more preferably from 8 to 30 parts by mass, based on 100 parts by mass of the silicon oxide-based matrix material component, in order for the obtainable ultraviolet-absorbing film to have the sufficient ultraviolet-absorbing ability and in order to secure mechanical strength of the ultraviolet-absorbing film.

Further, in the coating solution for forming an ultraviolet-absorbing film of the present invention, it is also possible that a functional group is introduced into the above-described organic ultraviolet absorber according to need, and a reaction product obtained by causing this and the above-described hydrolyzable silicon compound having the non-hydrolyzable monovalent organic group having a functional group to react with each other is incorporated, as the ultraviolet absorber.

As such a reaction product, concretely, a reaction product of the above-described benzophenone-type ultraviolet absorber preferably used in the present invention, which is, for example, a hydroxylated benzophenone-type compound, and an epoxidized hydrolyzable silicon compound, (which is also referred to as a “silylated benzophenone-type compound” hereinafter), can be cited. When the silylated benzophenone-type compound is incorporated into the coating solution for forming an ultraviolet-absorbing film, this compound forms a silicon oxide-based matrix having a cross-linked structure with the above-described hydrolyzable silicon compound. Thereby, the residue of the hydroxylated benzophenone-type compound derived from the silylated benzophenone-type compound is fixed to the silicon oxide-based matrix and bleeding out is prevented. As a result, it is becomes possible for the obtainable ultraviolet-absorbing film to maintain the ultraviolet-absorbing ability over a long period of time.

The hydroxylated benzophenone-type compound being a raw material of the above-described silylated benzophenone-type compound may be any compound as long as it is a compound having a benzophenone skeleton and having a hydroxyl group, and in the present invention, a benzophenone-type compound having from 2 to 4 hydroxyl groups, represented by the following general formula (a), is preferably used because it has an excellent ultraviolet-absorbing ability even after being silylated. According to the point of the ultraviolet-absorbing ability, particularly according to the point of the capability to absorb ultraviolet rays with a long wavelength of up to 380 nm, the number of hydroxyl groups contained in the hydroxylated benzophenone-type compound is more preferably 3 or 4.

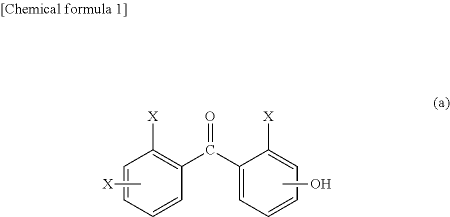

(In the formula, Xs, which may be the same with or different from one another, each indicate a hydrogen atom or a hydroxyl group, and at least one of them is a hydroxyl group.)

Further, as for the benzophenone-type compound having hydroxyl groups represented by the above-described general formula (a), in the present invention, 2,4-dihydroxybenzophenone, 2,2′,3-trihydroxybenzophenone, 4,5,6-trihydroxybenzophenone, 2,2′,4,4′-tetrahydroxybenzophenone, and the like are more preferred, and 2,2′,4,4′-tetrahydroxybenzophenone is particularly preferred. In the reaction of silylating the benzophenone-type compound having hydroxyl groups, one of the hydroxylated benzophenone-type compounds can be used alone, or two or more of them can also be used as a mixture.

As the epoxidized hydrolyzable silicon compound to be used for the reaction of silylating such a hydroxylated benzophenone-type compound, the trifunctional or bifunctional hydrolyzable silicon compound in which the above-described non-hydrolyzable monovalent organic group having an epoxy group is bonded to a silicon atom can be cited. Preferably, there can be cited 3-glycidoxypropyltrimethoxysilane, 3-glycidoxypropylmethyldimethoxysilane, 3-glycidoxypropyltriethoxysilane, 3-glycidoxypropylmethyldiethoxysilane, 2-(3,4-epoxycyclohexyl)ethyltrimethoxysilane, 2-(3,4-epoxycyclohexyl)ethylmethyldimethoxysilane, 2-(3,4-epoxycyclohexyl)ethyltriethoxysilane, 2-(3,4-epoxycyclohexyl)ethylmethyldiethoxysilane, and the like.

Among them, in the present invention, in terms of the solubility in the coating solution, or the like, as the above-described epoxidized hydrolyzable silicon compound, 3-glycidoxypropyltrimethoxysilane, 2-(3,4-epoxycyclohexyl)ethyltrimethoxysilane, 3-glycidoxypropylmethyldimethoxysilane, 2-(3,4-epoxycyclohexyl)ethylmethyldimethoxysilane, or the like is particularly preferably used. Incidentally, in the reaction of silylating the hydroxylated benzophenone-type compound, one of the epoxidized hydrolyzable silicon compounds can be used alone, or two or more of them can also be used as a mixture.

As a method of obtaining the reaction product of the hydroxylated benzophenone-type compound and the epoxidized hydrolyzable silicon compound, a method according to the normal silylation reaction is applicable without being limited in particular, and concretely, the following method can be cited.

At least one of the hydroxylated benzophenone-type compounds and at least one of the epoxidized hydrolyzable silicon compounds are caused to react under the existence of a catalyst according to need. The amount of the epoxidized hydrolyzable silicon compound to be used for the reaction is not particularly limited, and is preferably from 0.5 to 5.0 mol and is more preferably from 1.0 to 3.0 mol, per 1 mol of the hydroxylated benzophenone-type compound. If the amount of the epoxidized hydrolyzable silicon compound is less than 0.5 mol per 1 mol of the hydroxylated benzophenone-type compound, in the case where the reaction product is to be added to the coating solution for forming an ultraviolet-absorbing film of the present invention, the hydroxylated benzophenone-type compound that is not silylated is to exist substantially in the film to thus be likely to bleed out. Further, if the amount of the epoxidized hydrolyzable silicon compound exceeds 5.0 mol per 1 mol of the hydroxylated benzophenone-type compound, the absolute amount of the hydroxylated benzophenone-type compound relating to the ultraviolet-absorption is decreased, and thus the ultraviolet-absorbing ability is likely to deteriorate.

The catalyst to be used for the above-described silylation reaction is preferably a quaternary ammonium salt as described in JP-A-1983(S58)-10591(KOKAI). As the quaternary ammonium salt, tetramethylammonium chloride, tetraethylammonium chloride, benzyltrimethylammonium chloride, benzyltriethylammonium chloride, and the like can be cited as examples.

The amount of the catalyst to be added to the reaction system is not particularly limited, and the addition amount to be from 0.005 to 10 parts by mass is preferred, and the addition amount to be from 0.01 to 5 parts by mass is more preferred, based on 100 parts by mass of the total of the hydroxylated benzophenone-type compound and the epoxidized hydrolyzable silicon compound. If the addition amount of the catalyst is less than 0.005 parts by mass based on 100 parts by mass of the total of the hydroxylated benzophenone-type compound and the epoxidized hydrolyzable silicon compound, long time is required for the reaction, and if it exceeds 10 parts by mass, the catalyst is likely to deteriorate the stability of the coating solution in the case when the above reaction product is added to the coating solution for forming an ultraviolet-absorbing film of the present invention.

The above-described silylation reaction can be performed by heating the mixture of the hydroxylated benzophenone-type compound and the epoxidized hydrolyzable silicon compound in the above-described proportions for from 4 to 20 hours in a temperature range of from 50 to 150° C. under the existence of the catalyst preferably. This reaction may be performed in no solvent or in a solvent in which both the hydroxylated benzophenone-type compound and the epoxidized hydrolyzable silicon compound are dissolved, and from the viewpoint of control efficiency of the reaction and handling efficiency, the method of employing a solvent is preferred. As such a solvent, toluene, xylene, ethyl acetate, butyl acetate, and the like can be cited as examples. Further, as the amount of the solvent to be used, the amount of about from 10 to 300 parts by mass based on 100 parts by mass of the total of the hydroxylated benzophenone-type compound and the epoxidized hydrolyzable silicon compound can be cited.

As the silylated benzophenone-type compound preferably used in the present invention, a reaction product obtained by the reaction of one or two hydroxyl groups of the benzophenone-type compound containing three or more hydroxyl groups and an epoxy group of the epoxidized hydrolyzable silicon compound, and the like can be cited, and more preferably, 4-(2-hydroxy-3-(3-trimethoxysilyl)propoxy)propoxy)-2,2′,4′-tri-hydroxybenzophenone represented by the following formula (b), and the like can be cited. Incidentally, in the following formula (b), Me represents a methyl group.

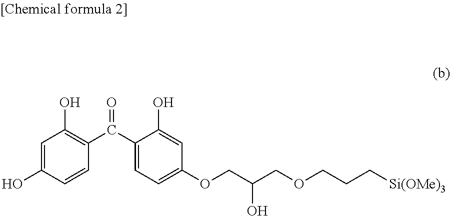

In the case when the coating solution for forming an ultraviolet-absorbing film of the present invention contains the silylated benzophenone-type compound as the ultraviolet absorber, the amount of it to be incorporated may be adjusted so that the amount of the residue of the hydroxylated benzophenone-type compound in the silylated benzophenone-type compound may become the content of the above-described ultraviolet absorber. Further, the silylated benzophenone-type compound, similarly to the hydrolyzable silicon compounds constituting the above-described silicon oxide-based matrix material component, may be incorporated as the partially hydrolyzed condensate, or may also be incorporated as the partially hydrolyzed co-condensate with these hydrolyzable silicon compounds.

### <Acid>

In the coating solution for forming an ultraviolet-absorbing film of the present invention, the silicon oxide-based matrix material component consisting of at least one selected from the above-described hydrolyzable silicon compounds that is contained in the coating solution for forming an ultraviolet-absorbing film is cured as will be described later, and thereby the ultraviolet-absorbing film is formed. The coating solution for forming an ultraviolet-absorbing film of the present invention contains the acid having a primary proton pKa (that is described as a “pKa1” according to need, hereinafter) of from 1.0 to 5.0, as an acid catalyst for promoting the above curing. In the present invention, such an acid is used as the acid catalyst, thereby making it possible to sufficiently secure colorlessness and transparency of the obtainable ultraviolet-absorbing film and maintain sufficient light resistance, and particularly prevent deterioration of the ultraviolet-absorbing ability by light.

As long as the above-described acid to be used for the present invention is an acid having a primary proton pKa of from 1.0 to 5.0, the acid is not limited in particular, and concretely, there can be cited acetic acid (pKa1=4.76), lactic acid (pKa1=3.64), maleic acid (pKa1=1.84), malonic acid (pKa1=2.60), oxalic acid (pKa1=1.04), and the like. Among them, acetic acid is particularly preferred in the present invention. One of them may be used alone, or two or more of them may also be used in combination.

The amount of the acid to be added can be set without any limitation in particular within a range where the function as the catalyst can be performed and a range where the colorlessness and transparency of the ultraviolet-absorbing film can be secured sufficiently, and concretely, as the molar concentration, based on the total mass of the coating solution, of the proton when the primary proton of the acid is completely dissociated, the acid is preferably contained in a proportion of from 0.005 to 5.0 mol/kg, and is more preferably contained in a proportion of from 0.01 to 3.5 mol/kg. If the concentration of the acid to be used is less than 0.005 mol/kg, there is sometimes a case that the function cannot be performed sufficiently as the catalyst, and if it exceeds 5.0 mol/kg, a hydrolysis rate is accelerated, and thus long-term storage stability is likely to be insufficient.

Incidentally, the coating solution for forming an ultraviolet-absorbing film of the present invention may also contain a curing catalyst according to need in addition to the above-described acid catalyst. As the curing catalyst, there can be cited an alkali metal salt such as a lithium salt, a sodium salt or a potassium salt, of an aliphatic carboxylic acid (formic acid, acetic acid, propionic acid, butyric acid, lactic acid, tartaric acid, succinic acid, or the like); a quaternary ammonium salt such as a benzyltrimethylammonium salt, a tetramethylammonium salt or a tetraethylammonium salt; a metal alkoxide or chelate of aluminum, titanium, cerium, or the like; ammonium perchlorate, ammonium chloride, ammonium sulfate, sodium acetate, imidazoles and a salt thereof, ammonium trifluoromethylsulfonate, bis(trifluoromethylsulfonyl)bromomethyl ammonium, and the like.

### <Water>

The coating solution for forming an ultraviolet-absorbing film of the present invention contains the water for hydrolyzing and condensation-polymerizing the above-described hydrolyzable silicon compounds, in addition to the silicon oxide-based matrix material component consisting of at least one selected from the above-described hydrolyzable silicon compounds, the ultraviolet absorber, and the acid having a first proton pKa of from 1.0 to 5.0.

The amount of the water contained in the coating solution for forming an ultraviolet-absorbing film of the present invention is not particularly limited as long as it is a sufficient amount to hydrolyze and condensation-polymerize the above-described hydrolyzable silicon compounds, and the amount to be from 1 to 20 equivalents is preferred, and the amount to be from 3 to 16 equivalents is more preferred, by a molar ratio to the amount calculated as SiO₂ of the above-described silicon oxide-based matrix material component. If the amount of the water is less than 1 equivalent by the above-described molar ratio, the hydrolysis is not likely to proceed, and at the time of coating, the coating solution is sometimes repelled depending on the substrate, or haze sometimes increases, and if it exceeds 20 equivalents, the hydrolysis rate is accelerated, and thus the long-term storage stability sometimes becomes insufficient.

Incidentally, in the case when as will be described later, fine silica particles are incorporated with the aim of improving the hardness such as abrasion resistance and scratching resistance, of the ultraviolet-absorbing film, particularly, as the amount of the water contained in the coating solution for forming an ultraviolet-absorbing film, the amount to be from 2 to 20 equivalents is preferred, and the amount to be from 3 to 17.5 equivalents is more preferred, by a molar ratio to the amount calculated as SiO₂ of the above-described silicon oxide-based matrix material component. If the amount of the water is less than 2 equivalents by the above-described molar ratio, the hardness of the ultraviolet-absorbing film sometimes decreases, and if it exceeds 20 equivalents, the hydrolysis rate is accelerated, and thus the long-term storage stability sometimes becomes insufficient. Incidentally, in the case when later-described water dispersion type colloidal silica is used as the fine silica particles, and in the case when the above-described ultraviolet absorber is used as a water dispersion, these waters are also treated as the water to be contained in the coating solution for forming an ultraviolet-absorbing film.

### <Other Components>

Further, the coating solution for forming an ultraviolet-absorbing film of the present invention can contain various optional additives according to need within a range not to impair the effects of the present invention, in addition to the silicon oxide-based matrix material component consisting of at least one selected from the above-described hydrolyzable silicon compounds, the ultraviolet absorber, the acid having a pKa1 of from 1.0 to 5.0, and the water which are essential components.

### (Flexibility-Imparting Component)

In the coating solution for forming an ultraviolet-absorbing film of the present invention, it is possible to incorporate a component to impart flexibility to the silicon oxide-based matrix obtained by curing the silicon oxide-based matrix material component consisting of at least one selected from the above-described hydrolyzable silicon compounds (referred to as the “flexibility-imparting component” hereinafter), which is preferred. The incorporation of the flexibility-imparting component can contribute to the prevention of occurrence of crack in the ultraviolet-absorbing film.

Incidentally, even though the above-described silicon oxide-based matrix material component has any constitution, the incorporation of the flexibility-imparting component is effective, and there is sometimes a case that particularly, the flexibility of the silicon oxide-based matrix constituted of only the above-described tetrafunctional hydrolyzable silicon compound is not sufficient, and thus if the tetrafunctional hydrolyzable silicon compound and the flexibility-imparting component are incorporated into the coating solution for forming an ultraviolet-absorbing film in a combined manner, the ultraviolet-absorbing film excellent in both mechanical strength and crack resistance can be formed easily.

As the flexibility-imparting component, there can be cited various organic resins such as, for example, a silicone resin, an acrylic resin, a polyester resin, a polyurethane resin, a hydrophilic organic resin containing a polyoxyalkylene group, and an epoxy resin, and an organic compound such as glycerin.

In the case when an organic resin is used as the flexibility-imparting component, as its form, a liquid form, fine particles, and the like are preferred. Further, the organic resin may be incorporated into the coating solution for forming an ultraviolet-absorbing film as a material component of a resin to be cross-linked and/or cured when the above-described silicon oxide-based matrix material component is cured and/or dried, and the like. In this case, within a range not to inhibit the property of the silicon oxide-based matrix, part of the above-described silicon oxide-based matrix material component and the organic resin material component being the flexibility-imparting component, and/or the organic resin may also react partially to be cross-linked.

As the silicone resin among the flexibility-imparting components, there can be preferably cited a silicone oil including various modified silicone oils, a silicone rubber in which diorganosilicone containing a hydrolyzable silyl group or a polymerizable group-containing organic group at its terminal is partially or all cross-linked, and the like.

As the hydrophilic organic resin containing a polyoxyalkylene group, polyethylene glycol (PEG), a polyether phosphate-based polymer, and the like can be preferably cited.

As the polyurethane resin, a polyurethane rubber, and the like can be cited, and as the acrylic resin, there can be preferably cited an acrylonitrile rubber, a homopolymer of an alkyl acrylate, a homopolymer of an alkyl methacrylate, a copolymer of an alkyl acrylate and a monomer copolymerizable with the alkyl acrylate, a copolymer of an alkyl methacrylate and a monomer copolymerizable with the alkyl methacrylate, and the like. As the monomer copolymerizable with the above-described alkyl(meth)acrylate, there can be used a hydroxy alkyl(meth)acrylate, a (meth)acrylate having a polyoxyalkylene group, a (meth)acrylate having a partial structure of the ultraviolet absorber, a (meth)acrylate having a silicon atom, or the like.

In the case when the epoxy resin is incorporated into the coating solution for forming an ultraviolet-absorbing film as the flexibility-imparting component, it is preferred to incorporate a combination of polyepoxides and a curing agent or polyepoxides alone which are material components of the epoxy resin. Polyepoxides are a generic name of compounds having plural epoxy groups. That is, the average number of epoxy groups of polyepoxides is two or more, and in the present invention, polyepoxide having from 2 to 10 epoxy groups on average is preferred.

As such polyepoxides, polyglycidyl compounds such as a polyglycidyl ether compound, a polyglycidyl ester compound, and a polyglycidyl amine compound are preferred. Further, polyepoxides may be either aliphatic polyepoxides or aromatic polyepoxides, and aliphatic polyepoxides are preferred. They are compounds having two or more epoxy groups.

Among them, the polyglycidyl ether compound is preferred, and the aliphatic polyglycidyl ether compound is particularly preferred. The polyglycidyl ether compound is preferably glycidyl ether of an alcohol having two or more functional groups, and is particularly preferably glycidyl ether of an alcohol having three or more functional groups because it is possible to improve the light resistance. Incidentally, such an alcohol is preferably an aliphatic alcohol, an alicyclic alcohol, or a sugar alcohol.

Concretely, there can be cited ethylene glycol diglycidyl ether, polyethylene glycol diglycidyl ether, propylene glycol diglycidyl ether, polypropylene glycol diglycidyl ether, neopentyl glycol diglycidyl ether, glycerol polyglycidyl ether, diglycerol polyglycidyl ether, polyglycerol polyglycidyl ether, trimethylolpropane polyglycidyl ether, sorbitol polyglycidyl ether, pentaerythritol polyglycidyl ether, and the like. One of them may be used, or two or more of them may also be used in combination.

Among them, polyglycidyl ether of an aliphatic polyol having three or more hydroxyl groups (one in which the average number of glycidyl groups (epoxy groups) per one molecule exceeds two), such as glycerol polyglycidyl ether, diglycerol polyglycidyl ether, polyglycerol polyglycidyl ether or sorbitol polyglycidyl ether is preferred because it is possible to improve the light resistance in particular. One of them may be used alone, or two or more of them may also be used in combination.

In the coating solution for forming an ultraviolet-absorbing film of the present invention, it is preferred to incorporate such an epoxy resin, particularly, polyepoxides, PEG (polyethylene glycol), glycerin, or the like among the above-described flexibility-imparting components because it is possible to impart sufficient flexibility to the obtainable ultraviolet-absorbing film while maintaining also the mechanical strength. Further, the above-described epoxy resin, particularly polyepoxides, PEG, glycerin, and the like, each have not only a function of preventing the occurrence of crack caused by long-term irradiation with light but also a function of improving the light resistance by preventing the deterioration of the ultraviolet-absorbing ability of the above-described benzophenone-type ultraviolet absorber while securing the colorlessness and transparency of the ultraviolet-absorbing film. Incidentally, in the present invention, polyepoxides are particularly preferred among them.

The amount of the above-described flexibility-imparting component to be incorporated is not limited in particular as long as it is an amount capable of imparting flexibility to the ultraviolet-absorbing film to improve the crack resistance without impairing the effects of the present invention, and the amount to be from 0.1 to 20 parts by mass is preferred, and the amount to be from 1.0 to 20 parts by mass is more preferred, based on 100 parts by mass of the above-described silicon oxide-based matrix material component.

### (Silica Fine Particles)

As the optional additive to be incorporated that the coating solution for forming an ultraviolet-absorbing film of the present invention can contain, the fine silica particles to be incorporated for improving the abrasion resistance of the ultraviolet-absorbing film can be cited. In the case when the fine silica particles are incorporated into the coating solution for forming an ultraviolet-absorbing film, they are preferably incorporated in the form of colloidal silica. Incidentally, colloidal silica is one in which fine silica particles are dispersed in a water or an organic solvent such as methanol, ethanol, isobutanol or propylene glycol monomethyl ether. When producing the coating solution for forming ultraviolet-absorbing film of the present invention, colloidal silica can be suitably incorporated to produce a coating solution for forming an ultraviolet-absorbing film containing fine silica particles. Further, in the case when the partially hydrolyzed (co-)condensate of the hydrolyzable silicon compound is produced, it is possible that colloidal silica is incorporated into the hydrolyzable silicon compound being the raw material of the partially hydrolyzed (co-)condensate and is subjected to partially hydrolytic (co-)condensation to obtain a partially hydrolyzed (co-)condensate containing fine silica particles, and it is also possible to, by using it, produce the coating solution for forming an ultraviolet-absorbing film of the present invention containing fine silica particles.

In the case when the fine silica particles are incorporated as an optional component into the coating solution for forming an ultraviolet-absorbing film of the present invention, fine silica particles having an average particle size (BET method) of from 1 to 100 nm are preferably incorporated. If the average particle size exceeds 100 nm, the particles diffusely reflect light, and thus the value of haze of the obtainable ultraviolet-absorbing film is increased, which is not sometimes preferred in terms of the optical quality. Further, the average particle size is particularly preferably from 5 to 40 nm. This is to maintain the colorlessness and transparency of the ultraviolet-absorbing film while imparting the abrasion resistance to the ultraviolet-absorbing film. Further, colloidal silica can be used in the form of either a water-dispersion type or an organic solvent dispersion type, and it is preferred to use the organic solvent-dispersion type. Further, it is also possible to contain fine inorganic particles such as alumina sol, titania sol, or ceria sol other than the fine silica particles in colloidal silica.

Further, in the case when the fine silica particles are incorporated as an optional component into the coating solution for forming an ultraviolet-absorbing film of the present invention, as the amount of the fine silica particles to be incorporated, the amount to be from 5 to 50 parts by mass is preferred, and the amount to be from 10 to 30 parts by mass is more preferred, based on 100 parts by mass of the above-described silicon oxide-based matrix material component in the coating solution for forming an ultraviolet-absorbing film. The range of the above-described incorporation amount is the range of the incorporation amount of the fine silica particles capable of maintaining the film-forming property of the ultraviolet-absorbing film while securing the sufficient abrasion resistance, and preventing the occurrence of crack and the deterioration of the colorlessness and transparency of the ultraviolet-absorbing film caused by agglomeration of the fine silica particles with one another, in the ultraviolet-absorbing film to be formed by using the coating solution for forming an ultraviolet-absorbing film of the present invention.

Incidentally, in the coating solution for forming an ultraviolet-absorbing film of the present invention, the above-described acid having a pKa1 of from 1.0 to 5.0 is used as the acid catalyst with the aim of improving the light resistance of the obtainable ultraviolet-absorbing film and particularly, preventing the deterioration of the ultraviolet-absorbing ability by light, and thereby, there is sometimes a case that deterioration is observed in the hardness, for example, the scratching resistance as compared with the case when a strong acid that has been used conventionally is used. But, fine silica particles to be incorporated for improving the abrasion resistance of the above-described ultraviolet-absorbing film also function for preventing such deterioration of the scratching resistance to thereby maintain the hardness of the ultraviolet-absorbing film at a constant level. A concrete aspect and preferred aspect of the fine silica particles are the same as described above. Further, the incorporation amount of the fine silica particles to be incorporated for preventing the deterioration of the scratching resistance is preferably from 0.5 to 50 parts by mass and is more preferably from 1.0 to 10 parts by mass, based on 100 parts by mass of the above-described silicon oxide-based matrix material component.

Here, for sufficiently exhibiting the function of preventing the deterioration of the scratching resistance by the above-described fine silica particles, in addition to the addition of the fine silica particles, the amount of the water to be incorporated for hydrolyzing and condensation-polymerizing the above-described hydrolyzable silicon compound and the like is preferably increased. As the incorporation amount of the water in the above case, concretely, by a molar ratio to the amount calculated as SiO₂ of the above-described silicon oxide-based matrix material component, the incorporation amount of from 2 to 20 equivalents can be preferably cited, and the incorporation amount of from 3 to 17.5 equivalents can be more preferably cited.

If one of the incorporation amounts of the fine silica particles and water is smaller than the lower limit of the above-described corresponding incorporation amount, the scratching resistance sometimes deteriorates. Further, if the fine silica particles are incorporated in excess of the above-described upper limit, the film-forming property of the ultraviolet-absorbing film is sometimes affected, and if the water is incorporated in excess of the above-described upper limit, the hydrolysis rate is accelerated, and thus the long-term storage stability sometimes becomes insufficient.

The coating solution for forming an ultraviolet-absorbing film of the present invention may further contain a light stabilizer with the aim of improving the light resistance. As the light stabilizer, a hindered amine-type light stabilizer (HALS) and the like can be preferably cited. The incorporation amount of the light stabilizer is preferably the amount to be from 0.001 to 0.015 parts by mass, and is more preferably the amount to be from 0.002 to 0.009 parts by mass, based on 100 parts by mass of the above-described silicon oxide-based matrix material component in the coating solution for forming an ultraviolet-absorbing film.

The coating solution for forming an ultraviolet-absorbing film of the present invention may further contain, with the aim of imparting functionality, functional fine particles such as indium tin oxide fine particles or antimony tin oxide fine particles and an organic dye.

Further, the coating solution for forming an ultraviolet-absorbing film of the present invention may also contain a surface active agent as an additive with the aim of improving the coating property on the substrate and the smoothness of an obtainable coating film.

The coating solution for forming an ultraviolet-absorbing film of the present invention may further contain additives such as a defoamer and a viscosity modifier with the aim of improving the coating property on the substrate, and may also contain an additive such as an adhesion-imparting agent with the aim of improving the adhesion to the substrate. The incorporation amount of these additives is preferably the amount to be from 0.01 to 2 parts by mass in each additive component, based on 100 parts by mass of the above-described silicon oxide-based matrix material component in the coating solution for forming an ultraviolet-absorbing film. Further, the coating solution for forming an ultraviolet-absorbing film of the present invention may also contain a dye, a pigment, a filler, and the like within a range not to impair the object of the present invention.

The coating solution for forming an ultraviolet-absorbing film of the present invention is prepared normally in such a form that the predetermined amounts of the above-described silicon oxide-based matrix material component, ultraviolet absorber, acid having a pKa1 of from 1.0 to 5.0, and water, each being the essential component, and the optional amounts of the various additives, and the like, each being the optional compounding agent, are dissolved or dispersed in a solvent. It is necessary that all non-volatile components in the above-described coating solution for forming an ultraviolet-absorbing film should be stably dissolved or dispersed in a solvent, and for such an aim, the solvent contains at least 20 mass % or more, preferably 50 mass % or more, of an alcohol.

As the alcohol to be used for such a solvent, methanol, ethanol, 1-propanol, 2-propanol, 1-butanol, 2-butanol, 2-methyl-1-propanol, 1-methoxy-2-propanol, 2-ethoxyethanol, 4-methyl-2-pentanol, 2-butoxyethanol, and the like are preferred. Among them, an alcohol having a boiling point of from 80 to 160° C. is preferred because the solubility of the above-described silicon oxide-based matrix material component is good and its coating property on the substrate is good. Concretely, ethanol, 1-propanol, 2-propanol, 1-butanol, 2-butanol, 2-methyl-1-propanol, 1-methoxy-2-propanol, 2-ethoxyethanol, 4-methyl-2-pentanol, and 2-butoxyethanol are preferred.

Further, as the solvent to be used for the coating solution for forming an ultraviolet-absorbing film of the present invention, in the case when the above-described coating solution contains the partially hydrolyzed (co-)condensate of the hydrolyzable silicon compound, when in the producing process of it, a lower alcohol to occur by hydrolyzing the hydrolyzable silicon compound (for example, alkyltrialkoxysilane) being the raw material, or the like is included, and colloidal silica in the form of an organic solvent dispersion type are used, an dispersion organic solvent of it, is also included.

Further, in the coating solution for forming an ultraviolet-absorbing film of the present invention, as the solvent other than those described above, a solvent other than an alcohol, which is miscible with water/alcohol, may be used in combination, and as such a solvent, there can be cited ketones such as acetone and acetylacetone; esters such as ethyl acetate and isobutyl acetate; and ethers such as propylene glycol monomethyl ether, dipropylene glycol monomethyl ether and diisopropyl ether.

The amount of the solvent to be used for the coating solution for forming an ultraviolet-absorbing film of the present invention is preferably from 100 to 1,900 parts by mass, and is more preferably from 250 to 900 parts by mass, based on 100 parts by mass of all the non-volatile components in the coating solution for forming an ultraviolet-absorbing film.

Further, in the case when the coating solution for forming an ultraviolet-absorbing film of the present invention contains the hydrolyzable silicon compound itself as the above-described silicon oxide-based matrix material component, a treatment in which they are subjected to partially hydrolytic (co-)condensation may also be performed in order to stabilize the coating solution when it is stored.

The above partially hydrolytic co-condensation is preferably performed under the existence of an acid catalyst similar to the one described above under a reaction condition similar to the one described above, similarly to the one described above. Normally, the aim can be achieved by mixing one or more of hydrolyzable silicon compounds in simple substance according to need and then stirring the mixture for a predetermined time at room temperature under the existence of the acid catalyst having a pKa1 of from 1.0 to 5.0. The incorporation of the above-described optional additive may be performed before the above partially hydrolytic co-condensation, or may also be performed after the above partially hydrolytic co-condensation. The addition of the catalyst and the pH adjustment are preferably performed after the above partially hydrolytic co-condensation.

### [Ultraviolet-Absorbing Glass Article of the Present Invention]

An ultraviolet-absorbing glass article of the present invention includes a glass substrate and an ultraviolet-absorbing film formed on at least part of the above-described glass substrate surface by using the above-described coating solution for forming an ultraviolet-absorbing film of the present invention.

The material for the glass substrate to be used for the ultraviolet-absorbing glass article of the present invention is not particularly limited, and ordinary soda lime glass, borosilicate glass, alkali free glass, quartz glass, and the like can be cited. Further, as the glass substrate for the ultraviolet-absorbing glass article of the present invention, it is also possible to use a glass substrate that absorbs ultraviolet rays and infrared rays.

Incidentally, the ultraviolet-absorbing glass article of the present invention is preferably applied to the application requiring the abrasion resistance particularly because the ultraviolet-absorbing film is excellent in abrasion resistance, and concretely, it is applied to a glass plate for a window of an automobile, particularly for a windshield and for a sliding window such as a side window.

The ultraviolet-absorbing glass article of the present invention is an ultraviolet-absorbing glass article that has the ultraviolet-absorbing film formed as described later by using the coating solution for forming an ultraviolet-absorbing film of the present invention constituted as above and in which the transmittance of light having a wavelength of 380 nm is suppressed to be small by the ultraviolet-absorbing ability of the contained ultraviolet absorber, particularly the benzophenone-type ultraviolet absorber that is preferably used. The ultraviolet-absorbing glass article of the present invention is calculated as a glass plate having a plate thickness of 3.5 mm, and concretely, the transmittance of light having a wavelength of 380 nm measured by using a spectrophotometer (U-3500: manufactured by Hitachi, Ltd.) is preferably 7.0% or less, is more preferably 4.0% or less, and is still more preferably 1.0% or less.

Further, the ultraviolet-absorbing film that the ultraviolet-absorbing glass article of the present invention has is formed by using the above-described coating solution for forming an ultraviolet-absorbing film of the present invention in which the above-described acid having a pKa1 of from 1.0 to 5.0 is used as an acid catalyst and further the above-described flexibility-imparting component such as polyepoxides, PEG, or glycerin is preferably incorporated to thereby become an ultraviolet-absorbing film in which the deteriorations of the mechanical strength such as the crack resistance and the ultraviolet-absorbing ability by light are prevented while the colorlessness and transparency of the ultraviolet-absorbing film are maintained and that has the durability against long-term irradiation with light, namely the light resistance.

Further, if the benzophenone-type ultraviolet absorber that is preferably used for the present invention as the ultraviolet absorber is used as the silylated benzophenone-type compound being the reaction product of the hydroxylated benzophenone-type compound and the epoxidized hydrolyzable silicon compound, bleeding out caused by the long-term use is decreased because the residue of the hydroxylated benzophenone-type compound is fixed to the silicon oxide-based matrix constituting the ultraviolet-absorbing film, and thus it is possible to make the ultraviolet-absorbing glass article of the present invention excellent in long-term storage stability of the ultraviolet-absorbing ability.

As a concrete method of applying the coating solution for forming an ultraviolet-absorbing film of the present invention on the above-described glass substrate, there can be cited a method that includes: (A) a process of applying the coating solution on the glass substrate to form a coating film; and (B) a process of removing the above-described organic solvent from the above-described coating film and curing the silicon oxide-based matrix material component consisting of at least one selected from the above-described hydrolyzable silicon compounds to form a cured product to thereby form the ultraviolet-absorbing film.

First, in the process (A), the coating solution is applied on the glass substrate to form a coating film of the coating solution. Incidentally, the coating film to be formed here is a coating film containing the above-described solvent. The method of applying the coating solution on the glass substrate is not particularly limited as long as it is a method that allows the coating solution to be applied uniformly, and it is possible to use a well-known method such as a flow coating method, a dip coating method, a spin coating method, a spray coating method, a flexo printing method, a screen printing method, a gravure printing method, a roll coating method, a meniscus coating method, or a die coating method. The thickness of the coating film of the coating solution is determined by considering the thickness of the ultraviolet-absorbing film to be obtained finally.

Next, as the process (B), the process of removing the solvent from the coating film of the coating solution on the glass substrate and curing the silicon oxide-based matrix material component of the above-described hydrolyzable silicon compound or the like to form the ultraviolet-absorbing film is performed.

The above-described coating film of the coating solution contains the volatile organic solvent, and the like, and thus, after forming the coating film by the coating solution, this volatile component is first evaporated and removed. The removal of this volatile component is preferably performed by heating and/or drying under reduced pressure. It is preferred to perform temporary drying at a temperature of from room temperature to 120° C. or so after the coating film of the coating solution being formed on the glass substrate, from the viewpoint of improving the leveling property of the coating film. Normally, during the operation of this temporary drying, concurrently with this, the volatile component is vaporized and removed, and thus the operation of removing the volatile component is included in the temporary drying. The time for the temporary drying, namely the time for the operation of removing the volatile component is preferably for from 3 seconds to 2 hours or so, although it depends also on the coating solution to be used for forming the coating film.

Incidentally, on this occasion, it is preferred that the volatile component should be removed sufficiently, but it does not have to be removed completely. That is, the organic solvent, and the like can also remain in the ultraviolet-absorbing film within a range not affecting the performance of the ultraviolet-absorbing film. Further, in the case when heating is performed in order to remove the above-described volatile component, the heating for producing the silicon oxide-based compound that is performed thereafter according to need, and the heating for removing the above-described volatile component, namely the temporary drying in general, may also be continuously performed.

After the volatile component is removed from the coating film as described above, the silicon oxide-based matrix material component of the above-described hydrolyzable silicon compound or the like is cured. This reaction can be performed at room temperature or under heating. In the case when the cured product (the silicon oxide-based matrix) is formed under heating, the upper limit of the heating temperature is preferably 200° C., and is particularly preferably 190° C. because the cured product contains an organic component. The cured product can be formed even at room temperature, and thus, the lower limit of the heating temperature is not particularly limited. However, in the case when acceleration of the reaction by heating is intended, the lower limit of the heating temperature is preferably 60° C., and is more preferably 80° C. Thus, this heating temperature is preferably from 60 to 200° C., and is more preferably from 80 to 190° C. The heating time is preferably for from a few minutes to a few hours, although it depends also on the coating solution to be used for forming the coating film.

The film thickness of the ultraviolet-absorbing film of the ultraviolet-absorbing glass article having the ultraviolet-absorbing film formed as above by using the coating solution for forming an ultraviolet-absorbing film of the present invention is preferably from 1.0 to 8.0 μm, and is more preferably from 1.5 to 7.0 μm. If the film thickness of the ultraviolet-absorbing film is less than 1.0 μm, the ultraviolet-absorbing effect sometimes becomes insufficient. Further, if the film thickness of the ultraviolet-absorbing film exceeds 8.0 μm, a crack sometimes occurs when the desired abrasion resistance is exhibited.

### EXAMPLES

Hereinafter, the present invention will be further explained with reference to Examples, and it should be understood that the present invention is by no means restricted to these Examples. Examples 1 to 10 to be explained below are working examples, and Examples 11 to 13 are comparative examples. Further, constituting compounds of reagents represented by trade names in each of the Examples are described below.

Constituting compounds of reagents represented by trade names in each of the Examples are described below.

SR-SEP: sorbitol-type polyglycidyl ether, manufactured by SAKAMOTO YAKUHIN KOGYO CO., LTD.

SOLMIX AP-1: a mixed solvent of ethanol:isopropyl alcohol:methanol=85:10:5 (mass ratio), manufactured by Japan Alcohol Trading CO., Ltd.

Methanol silica sol: colloidal silica having fine silica particles having an average primary particle size of from 10 to 20 nm dispersed in methanol at a solid content concentration of 30 mass %, manufactured by Nissan Chemical Industries, Ltd.

### (Composition Example of Silylated Ultraviolet-Absorber)

2,2′,4,4′-tetrahydroxybenzophenone (manufactured by BASF) being 49.2 g, 3-glycidoxypropyltrimethoxysilane (manufactured by Shin-Etsu Chemical Co., Ltd.) being 47.3 g, benzyltriethylammonium chloride (manufactured by JUNSEI CHEMICAL CO., LTD.) being 0.8 g, and butyl acetate (manufactured by JUNSEI CHEMICAL CO., LTD.) being 100 g were charged and heated to 60° C. while being stirred, and were dissolved and heated to 120° C. to be caused to react for 4 hours, to thereby obtain a silylated ultraviolet-absorber solution containing 4-(2-hydroxy-3-(3-trimethoxysilyl)propoxy)propoxy)-2,2′,4′-trihydroxybenzophenone (Si-THBP) represented by the above-described formula (b) at a solid content concentration of 49 mass %. Incidentally, 51 mass % of 4-(2-hydroxy-3-(3-trimethoxy-silyl)propoxy)propoxy)-2,2′,4′-trihydroxybenzophenone in the silylated ultraviolet-absorber solution is derived from 2,2′,4,4′-tetrahydroxybenzophenone.

### Example 1

SOLMIX AP-1 being 50.3 g, tetramethoxysilane being 12.1 g, 3-glycidoxypropyltrimethoxysilane being 3.8 g, the silylated ultraviolet-absorber solution obtained in the above-described composition example being 11.0 g, acetic acid being 11.4 g, and ion-exchange water being 11.4 g were charged to obtain a coating solution for forming an ultraviolet-absorbing film 1.

Thereafter, the coating solution for forming an ultraviolet-absorbing film 1 was applied by a spin coating method on a high heat-absorbing green glass having its surface cleaned (Tv: 75.2%, Tuv: 9.5%, transmittance of light with a wavelength of 380 nm: 38.5%, 10 cm in length, 10 cm in width, 3.5 mm in thickness, commonly called UVFL, manufactured by ASAHI GLASS CO., LTD.) and was dried in the atmosphere at 180° C. for 30 minutes to obtain an ultraviolet-absorbing film-attached glass plate. The properties of the obtained ultraviolet-absorbing film-attached glass plate were evaluated as follows. The evaluation results are shown in Table 2.

### [Evaluation]

1) Film Thickness:

Cross-sectional observation of the ultraviolet-absorbing film was performed by a scanning electron microscope (S-800: manufactured by Hitachi, Ltd.), and the film thickness [nm] was obtained from the obtained observation image.

2) Crack Test:

The ultraviolet-absorbing film after drying was observed visually and by a metallurgical microscope, and whether or not a crack was formed on the layer surface was judged. One in which no crack was formed, namely no crack was observed visually or by the microscope was evaluated as O, one in which a crack was not observed visually but observed by the microscope was evaluated as Δ, and one in which a crack was observed even visually was evaluated as X.

3) Spectral Properties (Transmittance):

The spectral properties were measured by using a spectrophotometer (U-3500: manufactured by Hitachi, Ltd.) and judged by the transmittance of light with a wavelength of 380 nm and by the visible light transmittance and the ultraviolet rays transmittance calculated in accordance with JIS-R3106.

4) YI (Degree of Yellowness):

YI was measured by using a spectrophotometer (U-3500: manufactured by Hitachi, Ltd.) and judged by the degree of yellowness calculated in accordance with JIS-K7105.

5) Abrasion Resistance:

A 1,000-rotation abrasion test was performed with a CS-10F abrasive wheel by using a Taber's abrasion resistance tester, by the method described in JIS-R3212 (1998), and then the degree of scratch before and after the test was measured by the haze (the haze value), and the abrasion resistance was evaluated by an increased amount of haze [%].

6) Accelerated Weathering Test (Light Resistance Evaluation):

A sample was set in a Super Xenon Weather Meter (SX75: manufactured by Suga Test Instruments Co., Ltd.), and the sample was exposed under conditions of an irradiation intensity of 150 W/m² (from 300 to 400 nm), a black panel temperature of 83° C. and humidity of 50RH %, and 1000 hours elapsed, and then the transmittance of light with a wavelength of 380 nm through the sample was measured, and judgment of crack was performed by the same method as that in 2) described above.

### Example 2

SOLMIX AP-1 being 52.2 g, tetramethoxysilane being 12.1 g, 3-glycidoxypropyltrimethoxysilane being 3.8 g, the silylated ultraviolet-absorber solution obtained in the above-described composition example being 11.0 g, lactic acid being 9.5 g, and ion-exchange water being 11.4 g were charged to obtain a coating solution for forming an ultraviolet-absorbing film 2. An ultraviolet-absorbing film-attached glass plate was made in the same manner as that in Example 1 except that the above-described coating solution 2 was used in place of the coating solution 1. The properties of the obtained ultraviolet-absorbing film-attached glass plate were evaluated in the same manner as that in Example 1. The evaluation results are shown in Table 2.

### Example 3

SOLMIX AP-1 being 61.5 g, tetramethoxysilane being 12.1 g, 3-glycidoxypropyltrimethoxysilane being 3.8 g, the silylated ultraviolet-absorber solution obtained in the above-described composition example being 11.0 g, malonic acid being 0.2 g, and ion-exchange water being 11.4 g were charged to obtain a coating solution for forming an ultraviolet-absorbing film 3. An ultraviolet-absorbing film-attached glass plate was made in the same manner as that in Example 1 except that the above-described coating solution 3 was used in place of the coating solution 1. The properties of the obtained ultraviolet-absorbing film-attached glass plate were evaluated in the same manner as that in Example 1. The evaluation results are shown in Table 2.

### Example 4

SOLMIX AP-1 being 52.5 g, tetramethoxysilane being 11.3 g, 3-glycidoxypropyltrimethoxysilane being 3.6 g, the silylated ultraviolet-absorber solution obtained in the above-described composition example being 10.3 g, SR-SEP as polyepoxide being 0.9 g, acetic acid being 10.7 g, and ion-exchange water being 10.7 g were charged to obtain a coating solution for forming an ultraviolet-absorbing film 4. An ultraviolet-absorbing film-attached glass plate was made in the same manner as that in Example 1 except that the above-described coating solution 4 was used in place of the coating solution 1. The properties of the obtained ultraviolet-absorbing film-attached glass plate were evaluated in the same manner as that in Example 1. The evaluation results are shown in Table 2.

### Example 5

SOLMIX AP-1 being 52.1 g, tetramethoxysilane being 11.4 g, 3-glycidoxypropyltrimethoxysilane being 3.7 g, the silylated ultraviolet-absorber solution obtained in the above-described composition example being 10.5 g, glycerin being 0.7 g, acetic acid being 10.8 g, and ion-exchange water being 10.8 g were charged to obtain a coating solution for forming an ultraviolet-absorbing film 5. An ultraviolet-absorbing film-attached glass plate was made in the same manner as that in Example 1 except that the above-described coating solution 5 was used in place of the coating solution 1. The properties of the obtained ultraviolet-absorbing film-attached glass plate were evaluated in the same manner as that in Example 1. The evaluation results are shown in Table 2.

### Example 6

SOLMIX AP-1 being 52.5 g, tetramethoxysilane being 11.3 g, 3-glycidoxypropyltrimethoxysilane being 3.6 g, the silylated ultraviolet-absorber solution obtained in the above-described composition example being 10.3 g, polyethylene glycol 400 (manufactured by KANTO CHEMICAL CO., INC.) being 0.9 g, acetic acid being 10.7 g, and ion-exchange water being 10.7 g were charged to obtain a coating solution for forming an ultraviolet-absorbing film 6. An ultraviolet-absorbing film-attached glass plate was made in the same manner as that in Example 1 except that the above-described coating solution 6 was used in place of the coating solution 1. The properties of the obtained ultraviolet-absorbing film-attached glass plate were evaluated in the same manner as that in Example 1. The evaluation results are shown in Table 2.

### Example 7

SOLMIX AP-1 being 45.0 g, tetramethoxysilane being 10.5 g, 3-glycidoxypropyltrimethoxysilane being 3.5 g, the silylated ultraviolet-absorber solution obtained in the above-described composition example being 10.2 g, SR-SEP as polyepoxide being 0.8 g, methanol silica sol as colloidal silica being 1.5 g, acetic acid being 9.9 g, and ion-exchange water being 18.6 g were charged to obtain a coating solution for forming an ultraviolet-absorbing film 7. An ultraviolet-absorbing film-attached glass plate was made in the same manner as that in Example 1 except that the above-described coating solution 7 was used in place of the coating solution 1. The properties of the obtained ultraviolet-absorbing film-attached glass plate were evaluated in the same manner as that in Example 1. The evaluation results are shown in Table 2.

### Example 8

SOLMIX AP-1 being 61.7 g, tetramethoxysilane being 12.1 g, 3-glycidoxypropyltrimethoxysilane being 3.8 g, the silylated ultraviolet-absorber solution obtained in the above-described composition example being 11.0 g, aqueous solution of 1% of oxalic acid being 4.8 g, and ion-exchange water being 6.7 g were charged to obtain a coating solution for forming an ultraviolet-absorbing film 8. An ultraviolet-absorbing film-attached glass plate was made in the same manner as that in Example 1 except that the above-described coating solution 8 was used in place of the coating solution 1. The properties of the obtained ultraviolet-absorbing film-attached glass plate were evaluated in the same manner as that in Example 1. The evaluation results are shown in Table 2.

### Example 9

SOLMIX AP-1 being 40.5 g, tetramethoxysilane being 16.0 g, 3-glycidoxypropyltrimethoxysilane being 10.6 g, 2,2′,4,4′-tetrahydroxybenzophenone being 2.7 g, acetic acid being 15.1 g, and ion-exchange water being 15.1 g were charged to obtain a coating solution for forming an ultraviolet-absorbing film 9. An ultraviolet-absorbing film-attached glass plate was made in the same manner as that in Example 1 except that the above-described coating solution 9 was used in place of the coating solution 1. The properties of the obtained ultraviolet-absorbing film-attached glass plate were evaluated in the same manner as that in Example 1. The evaluation results are shown in Table 2.

### Example 10

SOLMIX AP-1 being 30.4 g, tetraethoxysilane being 31.0 g, 2,2′,4,4′-tetrahydroxybenzophenone being 3.9 g, polyethylene glycol 400 (manufactured by KANTO CHEMICAL CO., INC.) being 3.2 g, acetic acid being 10.2 g, and ion-exchange water being 21.4 g were charged to obtain a coating solution for forming an ultraviolet-absorbing film 10. An ultraviolet-absorbing film-attached glass plate was made in the same manner as that in Example 1 except that the above-described coating solution 10 was used in place of the coating solution 1. The properties of the obtained ultraviolet-absorbing film-attached glass plate were evaluated in the same manner as that in Example 1. The evaluation results are shown in Table 2.

### Example 11

SOLMIX AP-1 being 61.8 g, tetramethoxysilane being 12.1 g, 3-glycidoxypropyltrimethoxysilane being 3.8 g, the silylated ultraviolet-absorber solution obtained in the above-described composition example being 11.0 g, aqueous solution of 10% of sulfuric acid being 2.4 g, and ion-exchange water being 9.3 g were charged to obtain a coating solution for forming an ultraviolet-absorbing film 11. An ultraviolet-absorbing film-attached glass plate was made in the same manner as that in Example 1 except that the above-described coating solution 11 was used in place of the coating solution 1. The properties of the obtained ultraviolet-absorbing film-attached glass plate were evaluated in the same manner as that in Example 1. The evaluation results are shown in Table 2. Incidentally, the crack test was performed on this ultraviolet-absorbing film-attached glass plate, and then a crack occurred in the ultraviolet-absorbing film, and thus the measurement of a change in transmittance as the accelerated weathering test was not performed.

### Example 12

SOLMIX AP-1 being 61.6 g, tetramethoxysilane being 12.1 g, 3-glycidoxypropyltrimethoxysilane being 3.8 g, the silylated ultraviolet-absorber solution obtained in the above-described composition example being 11.0 g, aqueous solution of 10% of nitric acid being 1.3 g, and ion-exchange water being 10.2 g were charged to obtain a coating solution for forming an ultraviolet-absorbing film 12. An ultraviolet-absorbing film-attached glass plate was made in the same manner as that in Example 1 except that the above-described coating solution 12 was used in place of the coating solution 1. The properties of the obtained ultraviolet-absorbing film-attached glass plate were evaluated in the same manner as that in Example 1. The evaluation results are shown in Table 2.

### Example 13

SOLMIX AP-1 being 17.4 g, tetramethoxysilane being 19.1 g, 3-glycidoxypropyltrimethoxysilane being 12.7 g, 2,2′,4,4′-tetrahydroxybenzophenone being 3.2 g, 0.1N nitric acid (manufactured by JUNSEI CHEMICAL CO., LTD.) being 48.4 g were charged to obtain a coating solution for forming an ultraviolet-absorbing film 13. An ultraviolet-absorbing film-attached glass plate was made in the same manner as that in Example 1 except that the above-described coating solution 13 was used in place of the coating solution 1. The properties of the obtained ultraviolet-absorbing film-attached glass plate were evaluated in the same manner as that in Example 1. The evaluation results are shown in Table 2. Incidentally, the crack test was performed on this ultraviolet-absorbing film-attached glass plate, and then a crack occurred in the ultraviolet-absorbing film, and thus the measurement of a change in transmittance as the accelerated weathering test was not performed.

The compositions of the coating solutions each for forming an ultraviolet-absorbing film obtained in Examples 1 to 13 described above are summarized in Table 1. Incidentally, in Table 1, abbreviations of the compounds used represent the following compounds.

TMOS: tetramethoxysilane

TEOS: tetraethoxysilane

GPTMS: 3-glycidoxypropyltrimethoxysilane

Si-THBP: silylated ultraviolet absorber obtained in the composition example

THBP: 2,2′,4,4′-tetrahydroxybenzophenone

PEG400: polyethylene glycol 400

Further, in the case of Si-THBP being used as the ultraviolet absorber, the amount of the ultraviolet absorber in Table 1 indicates the amount of the part derived from THBP in Si-THBP.

TABLE 1

| | SOLID CONTENT COMPOSITION IN COATING | | | | | | | | |
|---|---|---|---|---|---|---|---|---|---|
| | SOLUTION FOR FORMING ULTRAVIOLET-ABSORBING FILM (PART BY MASS) | | | | | | | | |
| | Hydrolyzable Silicon Compound | | | | Flexibility- | | | | Fine |
| | (Silicon Oxide Matrix Material Component) | | | | Imparting | | Ultraviolet | | Silica |
| | Tetrafunctionality | | Trifunctionality | | Component | | Absorber | | Particle |
| EXAMPLE | Type | Amount | Type | Amount | Type | Amount | Type | Amount | Amount |
| 1 | TMOS | 76.1 | GPTMS | 23.9 | — | — | Si-THBP | 17.3 | — |
| 2 | TMOS | 76.1 | GPTMS | 23.9 | — | — | Si-THBP | 17.3 | — |
| 3 | TMOS | 76.1 | GPTMS | 23.9 | — | — | Si-THBP | 17.3 | — |
| 4 | TMOS | 75.8 | GPTMS | 24.2 | SR-SEP | 6.0 | Si-THBP | 17.3 | — |
| 5 | TMOS | 75.5 | GPTMS | 24.5 | Glycerin | 4.6 | Si-THBP | 17.4 | — |
| 6 | TMOS | 75.8 | GPTMS | 24.2 | PEG400 | 6.0 | Si-THBP | 17.3 | — |
| 7 | TMOS | 75.0 | GPTMS | 25.0 | SR-SEP | 5.7 | Si-THBP | 18.2 | 3.2 |
| 8 | TMOS | 76.1 | GPTMS | 23.9 | | — | Si-THBP | 17.3 | — |
| 9 | TMOS | 60.2 | GPTMS | 39.8 | — | — | THBP | 10.2 | — |
| 10 | TEOS | 100.0 | — | — | PEG400 | 10.3 | THBP | 12.6 | |
| 11 | TMOS | 76.1 | GPTMS | 23.9 | — | — | Si-THBP | 17.3 | — |
| 12 | TMOS | 76.1 | GPTMS | 23.9 | — | — | Si-THBP | 17.3 | — |
| 13 | TMOS | 60.1 | GPTMS | 39.9 | — | | THBP | 10.1 | — |

| | CONTENTS OF VARIOUS COMPONENTS IN COATING | | | | |
|---|---|---|---|---|---|
| | SOLUTION FOR FORMING ULTRAVIOLET-ABSORBING FILM | | | | |
| | | | | Water | Silicon Oxide Matrix |
| | | | | Molar Equivalent to | Material Component |
| | Acid | | | Amount Calculated as | Concentration |
| | | | Proton | SiO₂ of Silicon | Calculated as |
| | | | Concentration | Oxide Matrix | SiO₂ in Coating |
| EXAMPLE | Type | pKa1 | [Mole/kg] | Material Component | Solution [wt %] |
| 1 | Acetic Acid | 4.76 | 1.9 | 6.6 | 5.7 |
| 2 | Lactic Acid | 3.64 | 1.4 | 6.6 | 5.7 |
| 3 | Malonic Acid | 2.60 | 0.05 | 6.6 | 5.7 |
| 4 | Acetic Acid | 4.76 | 1.8 | 6.6 | 5.4 |
| 5 | Acetic Acid | 4.76 | 1.8 | 6.6 | 5.4 |
| 6 | Acetic Acid | 4.76 | 1.8 | 6.6 | 5.4 |
| 7 | Acetic Acid | 4.76 | 1.7 | 12.3 | 5.0 |
| 8 | Oxalic Acid | 1.04 | 0.01 | 3.9 | 5.7 |
| 9 | Acetic Acid | 4.76 | 1.7 | 5.6 | 8.9 |
| 10 | Acetic Acid | 4.76 | 1.7 | 8.0 | 8.9 |
| 11 | Sulfuric Acid | −5.0 | 0.05 | 5.4 | 5.7 |
| 12 | Nitric Acid | −1.3 | 0.06 | 5.9 | 5.7 |
| 13 | Nitric Acid | −1.3 | 0.04 | 15.0 | 10.8 |

TABLE 2

| | | | | | | INCREASED AMOUNT | AFTER ACCELERATED | |
|---|---|---|---|---|---|---|---|---|
| | INITIAL VALUE | | | | | OF HAZE AFTER | WEATHERING TEST | |
| | FILM | | TRANSMITTANCE | | | ABRASION | | TRANSMITTANCE |
| | THICKNESS | | OF WAVELENGTH | | HAZE | RESISTANCE TEST | | OF WAVELENGTH |
| | [nm] | CRACK | OF 380 nm [%] | YI | [%] | [%] | CRACK | OF 380 nm [%] |
| EXAMPLE 1 | 2600 | ◯ | 0.7 | 3.5 | 0.2 | 2.5 | ◯ | 4.1 |
| EXAMPLE 2 | 2500 | ◯ | 0.8 | 3.7 | 0.1 | 2.9 | ◯ | 5.5 |
| EXAMPLE 3 | 2300 | ◯ | 0.9 | 3.5 | 0.2 | 3.1 | ◯ | 7.6 |
| EXAMPLE 4 | 3200 | ◯ | 0.6 | 3.9 | 0.3 | 2.1 | ◯ | 0.9 |
| EXAMPLE 5 | 3100 | ◯ | 0.6 | 3.3 | 0.2 | 2.9 | ◯ | 1.6 |
| EXAMPLE 6 | 3100 | ◯ | 0.6 | 3.4 | 0.2 | 2.9 | ◯ | 1.4 |
| EXAMPLE 7 | 4000 | ◯ | 0.4 | 4.0 | 0.1 | 2.0 | ◯ | 0.8 |
| EXAMPLE 8 | 2600 | ◯ | 0.8 | 3.7 | 0.1 | 3.0 | ◯ | 10.5 |
| EXAMPLE 9 | 3500 | ◯ | 0.8 | 4.1 | 0.1 | 3.3 | ◯ | 5.0 |
| EXAMPLE 10 | 3000 | ◯ | 0.7 | 4.2 | 0.1 | 3.2 | ◯ | 6.5 |
| EXAMPLE 11 | 2000 | ◯ | 1.0 | 10.7 | 0.3 | 3.0 | X | — |
| EXAMPLE 12 | 2500 | ◯ | 0.6 | 8.0 | 0.1 | 3.0 | ◯ | 16.5 |
| EXAMPLE 13 | 3500 | ◯ | 0.8 | 6.7 | 0.1 | 3.2 | X | — |

As shown in Table 2, the ultraviolet-absorbing films formed in Examples 11 to 13 being the comparative examples each have the ultraviolet-absorbing ability but are inferior to the colorlessness and transparency, and the resistance to deterioration of the ultraviolet-absorbing ability by light is insufficient. On the other hand, the ultraviolet-absorbing films formed in Examples 1 to 10 being the working examples are each excellent in the ultraviolet-absorbing ability and also excellent in mechanical properties such as the abrasion resistance and crack resistance, and sufficiently secure the colorlessness and transparency and have less deterioration of the ultraviolet-absorbing ability caused by long-time light exposure.

The ultraviolet-absorbing glass article of the present invention has excellent ultraviolet-absorbing property and mechanical strength and is also excellent in weather resistance and durability, and thus is also applicable to a place highly requiring mechanical durability such as abrasion resistance and crack resistance and weather resistance, which is a door glass plate for an automobile, and the like.

What is claimed is:

1. A coating solution for forming an ultraviolet-absorbing film, comprising:
a silicon oxide-based matrix material component consisting of at least one selected from hydrolyzable silicon compounds;
an ultraviolet absorber;
an acid having a primary proton pKa of from 1.0 to 5.0; and
a water.

2. The coating solution for forming an ultraviolet-absorbing film according to claim 1,
wherein the acid is contained in a proportion of from 0.005 to 5.0 mol/kg as the molar concentration, based on the total mass of the coating solution, of the proton when the primary proton of the acid is completely dissociated.

3. The coating solution for forming an ultraviolet-absorbing film according to claim 1,
wherein the acid is at least one selected from the group consisting of acetic acid, lactic acid, maleic acid, malonic acid, and oxalic acid.

4. The coating solution for forming an ultraviolet-absorbing film according to claims 1,
wherein the silicon oxide-based matrix material component contains a tetrafunctional hydrolyzable silicon compound which may contain a partially hydrolyzed condensate thereof as the main component and, the coating solution for forming an ultraviolet-absorbing film further comprises a flexibility-imparting component.

5. The coating solution for forming an ultraviolet-absorbing film according to claims 1,
wherein the silicon oxide-based matrix material component contains a tetrafunctional hydrolyzable silicon compound and a trifunctional hydrolyzable silicon compound which may contain their respective partially hydrolyzed condensates and/or a partially hydrolyzed co-condensate of both of them as the main component.

6. The coating solution for forming an ultraviolet-absorbing film according to claims 1,
wherein the ultraviolet absorber is a benzophenone-type ultraviolet absorber.

7. The coating solution for forming an ultraviolet-absorbing film according to claim 6,
wherein the benzophenone-type ultraviolet absorber is a hydrolyzable silicon compound obtained by causing a hydroxylated benzophenone-type compound and an epoxidized hydrolyzable silicon compound to react with each other.

8. The coating solution for forming an ultraviolet-absorbing film according to claims 1,
wherein the content of the ultraviolet absorber is from 1 to 50 parts by mass based on 100 parts by mass of the silicon oxide-based matrix material component.

9. The coating solution for forming an ultraviolet-absorbing film according to claims 1,
wherein the content of the water is from 1 to 20 equivalents by a molar ratio to the amount calculated as SiO₂ of the silicon oxide-based matrix material component.

10. The coating solution for forming an ultraviolet-absorbing film according to claims 1, further comprising fine silica particles.

11. The coating solution for forming an ultraviolet-absorbing film according to claim 10,
wherein the content of the fine silica particles is from 0.5 to 50 parts by mass based on 100 parts by mass of the silicon oxide-based matrix material component.

12. The coating solution for forming an ultraviolet-absorbing film according to claims 1,
wherein the content of the silicon oxide-based matrix material component to the total mass of the coating solution is from 1 to 20 mass % as the content of SiO₂ when silicon atoms contained in the component are calculated as SiO₂.

13. An ultraviolet-absorbing glass article, comprising:
a glass substrate; and
an ultraviolet-absorbing film formed on at least part of the glass substrate surface by using the coating solution for forming an ultraviolet-absorbing film according to claims 1.
